(19) United States
(12) Patent Application Publication
(10) Pub. No.: US 2026/0056985 A1
(43) Pub. Date: Feb. 26, 2026

(54) METHOD AND APPARATUS FOR QUESTION-ANSWERING, RELATED DEVICE AND COMPUTER PROGRAM PRODUCT

(71) Applicant: CHENGDU ZHUOZHUO TECHNOLOGY CO., LTD, Chengdu (CN)

(72) Inventors: Jinsong LIU, Chengdu (CN); Yang SHI, Chengdu (CN); Ruifeng ZHENG, Chengdu (CN)

(73) Assignee: CHENGDU ZHUOZHUO TECHNOLOGY CO., LTD, Chengdu (CN)

(21) Appl. No.: 19/078,940

(22) Filed: Mar. 13, 2025

(30) Foreign Application Priority Data
Aug. 26, 2024 (CN) 202411174117.1

(51) Int. Cl. G06F 16/3329

(52) U.S. Cl. CPC G06F 16/33295

(57) ABSTRACT

A method and an apparatus for question-answering, a related device, and a computer program product are provided. An answering content corresponding to question information is generated via first large models in a configured large model set. A second large model is pre-configured, a consistency of the answering contents generated by the respective first large models is detected using reasoning capability of the second large model, and a determination result of whether each pair of the answering contents in the answering content set is consistent is obtained. If the determination result indicates that at least one pair of answering contents is consistent, the consistent answering contents are outputted as a final answer. An error may exist in a single large model, but if at least one pair of answering contents is consistent, an accuracy rate of the consistent answering contents can be improved.

### CROSS-REFERENCE TO RELATED APPLICATIONS

The present application claims priority to Chinese Patent Application No. 202411174117.1, titled “METHOD AND APPARATUS FOR QUESTION-ANSWERING, RELATED DEVICE AND COMPUTER PROGRAM PRODUCT”, filed on Aug. 26, 2024 with the China National Intellectual Property Administration, which is incorporated herein by reference in its entirety.

### FIELD

The present disclosure relates to the technical field of artificial intelligence, and in particular to a method and an apparatus for question-answering, a related device and a computer program product.

### BACKGROUND

With the development of the artificial intelligence technology, artificial intelligence models are generally applied to all walks of life, such as intelligent question-answering scenarios. Especially with the rise of large models, a processing efficiency for various types of tasks is significantly improved by means of powerful capabilities of large models such as natural semantic understanding, logical reasoning and text generation.

At present, various types of large models exist in the market, and different large models have different network structures, training strategies, and capabilities. A single large model has limited performance, prone to generate wrong answers in some question-answering scenarios. Therefore, attention is drawn to the problem of how to improve the effect of large models in intelligent question-answering scenarios.

### SUMMARY

In view of the above problem, a method and an apparatus for question-answering, a related device and a computer program product are provided according to the present disclosure, to achieve the objectives of improving the effect of large models in intelligent question-answering scenarios. Specific solutions are as follows.

In a first aspect of the present disclosure, a method for question-answering is provided. The method for question-answering includes:
obtaining question information;
invoking first large models in a configured large model set to instruct each of the first large models to generate an answering content corresponding to the question information, and obtaining an answering content set, where the large model set includes more than two different first large models;
invoking a configured second large model to instruct the second large model to determine, based on the question information, whether each pair of the answering contents in the answering content set is consistent, and obtaining a determination result of whether the each pair of the answering contents in the answering content set is consistent; and
outputting, in response to the determination result indicating that at least one pair of the answering contents is consistent, the consistent answering contents as a final answer.

In an embodiment, in another implementation in the first aspect of the present disclosure, the method for question-answering further includes:
selecting, in response to the determination result indicating that all the answering contents in the answering content set are inconsistent, a first large model with an advantage processing question type which includes a question type of the question information as a target first large model by referring to advantage processing question types of the first large models in the configured large model set; and
outputting an answering content generated by the target first large model that corresponds to the question information as the final answer.

In an embodiment, in another implementation in the first aspect of the present disclosure, the invoking a configured second large model to instruct the second large model to determine, based on the question information, whether each pair of the answering contents in the answering content set is consistent, and obtaining a determination result of whether the each pair of the answering contents in the answering content set is consistent includes:
continuously detecting whether the first large models have completed generating the answering contents, combining, in response to obtaining two answering contents generated by the first large models, the generated answering contents in a pair, and invoking the second large model to instruct the second large model to determine whether the two answering contents in each pair of the answering contents are consistent, until the determination result of whether the each pair of the answering contents in the answering content set is consistent is obtained;
where the outputting, in response to the determination result indicating that at least one pair of the answering contents is consistent, the consistent answering contents as a final answer includes:
continuously detecting the determination result outputted by the second large model, and outputting the consistent answering content as the final answer on detecting the determination result indicating that one pair of answering contents is consistent for a first time.

In an embodiment, in another implementation in the first aspect of the present disclosure, the method for question-answering further includes:
determining a risk level of the final answer based on the determination result, and outputting the determined risk level of the final answer, where the risk level characterizes a risk of error in the final answer.

In an embodiment, in another implementation in the first aspect of the present disclosure, the method for question-answering further includes:
obtaining an accuracy rate of the target first large model for the question type of the question information, where the target first large model is obtained through a pre-test; and
determining a risk level of the final answer based on the accuracy rate and outputting the determined risk level of the final answer, where the risk level characterizes a risk of error in the final answer.

In an embodiment, in another implementation in the first aspect of the present disclosure, the determining a risk level of the final answer based on the determination result includes:
determining the risk level of the final answer based on the number of the answering contents consistent with the final answer in the determination result, where the risk level corresponding to the greater number indicates a lower risk of error in the final answer.

In an embodiment, in another implementation in the first aspect of the present disclosure, the second large model is obtained by performing fine-tuning training on a general large model using question-answering training data, and the question-answering training data includes sample question information, an answering content pair corresponding to the sample question information, and a determination result of whether the answering content pair is consistent.

In an embodiment, in another implementation in the first aspect of the present disclosure, the method for question-answering further includes:
performing a cross validation on the determination result of the consistency of the each pair of the answering contents in the answering content set, and marking, in response to determining that answering contents in the answering content set fail the validation, the answering contents failing the validation as training data for performing update training on the second large model.

In a second aspect of the present disclosure, an apparatus for question-answering is provided. The apparatus for question-answering includes a question obtaining unit, a first large model invocation unit, a second large model invocation unit and a first answer output unit.

The question obtaining unit is configured to obtain question information.

The first large model invocation unit is configured to invoke first large models in a configured large model set to instruct each of the first large models to generate an answering content corresponding to the question information, and obtain an answering content set. The large model set includes more than two different first large models.

The second large model invocation unit is configured to invoke a configured second large model to instruct the second large model to determine whether each pair of the answering contents in the answering content set is consistent based on the question information, and obtain a determination result of whether the each pair of the answering contents in the answering content set is consistent.

The first answer output unit is configured to output, in response to the determination result indicating that at least one pair of the answering contents is consistent, the consistent answering contents as a final answer.

In a third aspect of the present disclosure, an electronic device is provided. The electronic device includes a memory and a processor.

The memory is configured to store a program.

The processor is configured to execute the program to perform the method for question-answering according to the first aspect of the present disclosure.

In a fourth aspect of the present disclosure, a readable storage medium is provided. The readable storage medium stores a computer program. The computer program, when being executed by a processor, performs the method for question-answering according to any one of the embodiments in the first aspect of the present disclosure.

In a fifth aspect of the present disclosure, a computer program product is provided. The computer program product includes a computer program. The computer program, when being executed by a processor, performs the method for question-answering according to any one of the embodiments in the first aspect of the present disclosure.

On the basis of the above technical solutions, multiple large models are integrated for question-answering processing according to the present disclosure. An answering content corresponding to question information is generated via first large models in a configured large model set. Further, the second large model is pre-configured according to the present disclosure. The second large model is used to detect the consistency of the answering contents generated by the respective first large models, so as to obtain the determination result of whether each pair of answering contents in the answering content set is consistent. If the determination result indicates that at least one pair of answering contents is consistent, the consistent answering contents are outputted as the final answer. In view of the fact that an error may exist in an answering content generated by a single large model, mutual validation of the consistency of the answering contents generated by any two large models is performed. If at least one pair of answering contents is consistent, an accuracy rate of the consistent answering contents is significantly improved. Therefore, the consistent answering contents are outputted as the final answer, thus significantly improving the accuracy rate of the answering result.

Moreover, according to the present disclosure, during verifying whether the answering contents generated by the different first large models are consistent, the capability of the second large model is utilized. The second large model detects the consistency of each pair of answering contents by combining the question information (that is, the context information). In this manner, the reasoning capability of the second large model is fully used, thus improving the accuracy of the consistency detection.

### BRIEF DESCRIPTION OF THE DRAWINGS

By reading the detailed description of preferred embodiments below, various other advantages and benefits are clear to those skilled in the art. The accompanying drawings are only used for illustrating the preferred embodiments rather than limiting the present application. Moreover, throughout the accompanying drawings, same reference numerals represent identical components. In the accompanying drawings:

FIG. 1 is a schematic diagram of an implementation system architecture of a method for question-answering according to an embodiment of the present disclosure;

FIG. 2 is a schematic structural diagram of a terminal according to an embodiment of the present disclosure;

FIG. 3 is a schematic structural diagram of a server according to an embodiment of the present disclosure;

FIG. 4 is a flowchart of a method for question-answering according to an embodiment of the present disclosure;

FIG. 5 is a schematic structural diagram of an apparatus for question-answering according to an embodiment of the present disclosure; and

FIG. 6 is a schematic structural diagram of an electronic device according to an embodiment of the present disclosure.

Reference numerals:

| | | | |
|---|---|---|---|
| 100: terminal, | 200: server, | 110: radio frequency unit, | 120: memory, |
| 130: input unit, | 131: touch screen, | 132: other input devices, | |
| 140: display unit, | 150: camera, | 160: audio circuit, | 161: loudspeaker, |
| 162: microphone, | 163: headphone jack, | 170: processor, | |
| 180: external interface, | 190: power supply, | 201: bus, | |
| 202: processing circuit, | 203: communication interface, | | |
| 204: storage circuit, | 601: processing apparatus, | 602: ROM, | 603: RAM, |
| 604: public transmission line, | 605: I/O interface, | 606: input apparatus, | |
| 607: output apparatus, | 608: storage apparatus, | 609: communication apparatus, | |
| 11: question obtaining unit, | 12: first large model invocation unit, | | |
| 13: second large model invocation unit, | 14: first answer output unit. | | |

### DETAILED DESCRIPTION

Before description of the solutions according to the present disclosure, relevant concepts involved in the present disclosure are firstly explained.

“prompt” indicates a prompt instruction, which is sent to AI when interacting with AI (such as artificial intelligence model). The prompt instruction may be a text description, such as “Please recommend a piece of pop music for me” inputted when a user interact with AI, or may be a parameter description in a determined format, such description of relevant drawing parameters for guiding AI to draw in a determined format.

A large model, in the field of artificial intelligence, generally refers to a large-scale pre-trained model. The description “large” indicates that the model implements pre-training on large amounts of data and can be migrated to various downstream tasks. The full English name of the large models is Large Pre-Trained Models or Large-scale Pre-Training Models. Large models are characterized by their large scale, and billions or more of parameters included in the large models assist them in learning complex patterns in the data. The large models are provided with capabilities including, but are not limited to, contextual learning, instruction following, code generation, and sequential reasoning. The Large model may include a large language model (LLM) and a multimodal large model. The large language model is mainly used to process text modal data. The multimodal large model further integrates multimodal capabilities on the basis of the large language model, and can process multimodal information, such as images, texts, audios and the like.

Technical solutions in embodiments of the present disclosure will be described clearly and completely hereinafter in conjunction with the accompanying drawings in the embodiments of the present disclosure. It is apparent that the described embodiments are only a part of the embodiments of the present disclosure and not all of the embodiments. Based on the embodiments of the present disclosure, all other embodiments obtained by those skilled in the art without any creative work fall into the protection scope of the present disclosure.

A method for question-answering is provided according to the present disclosure, applicable to various question-answering scenarios, especially the question-answering scenario for closed questions. Users may ask questions for the closed questions, and the answer corresponding to the questions is provided based on the capability of the large models according to the present disclosure. The closed questions refer to questions whose answer is explicitly limited or preset, selected from given options, or strictly controlled within a specific range. Such questions generally have clear, unique, or limited answer options.

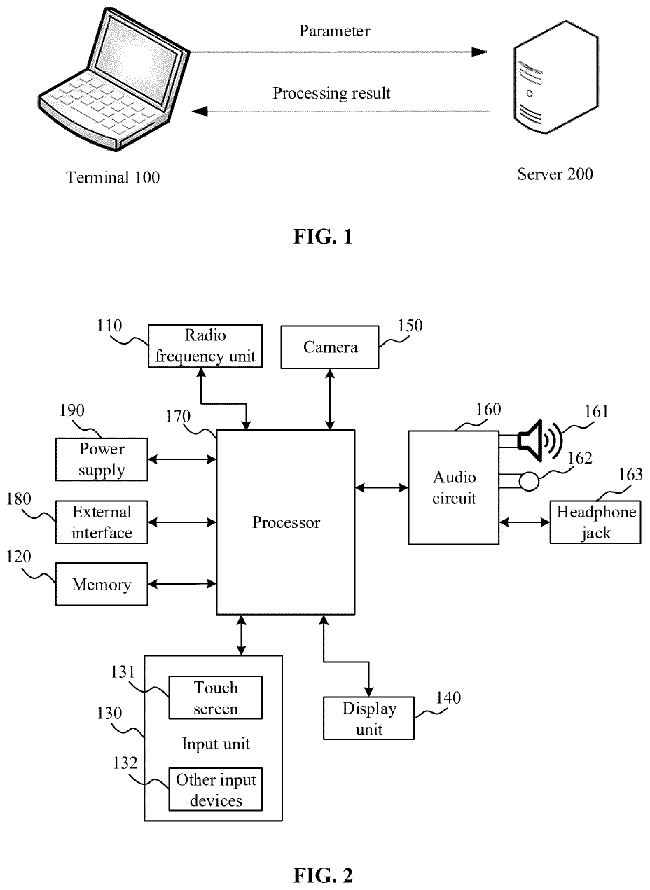

The method for question-answering provided in the present disclosure may be applied to a system architecture shown in FIG. 1. The system may include a terminal 100, and a server 200. The server 200 may include one or more servers (the server 200 including one server is taken as an example for illustration shown in FIG. 1).

The terminal 100 or the server 200 may be configured to independently perform the method for question-answering according to embodiments of the present disclosure. In addition, the terminal 100 and the server 200 may be configured to cooperatively perform the method for question-answering according to embodiments of the present disclosure.

A product form of the terminal 100 in FIG. 1 is described below.

In an embodiment of the present disclosure, the terminal 100 may be a mobile phone, a tablet computer, a learning machine, a teaching screen, a wearable device, an on-board device, a conference terminal, an augmented reality (AR)/virtual reality (VR) device, a laptop, an ultra-mobile personal computer (UMPC), a netbook, a personal digital assistant (PDA), and the like, which is not limited in embodiment of the present disclosure.

FIG. 2 shows a schematic diagram of a hardware structure of the terminal 100 according to an embodiment.

Referring to FIG. 2, the terminal 100 may include a radio frequency unit 110, a memory 120, an input unit 130, a display unit 140, a camera 150 (optional), an audio circuit 160, a loudspeaker 161, a microphone 162, a headphone jack 163 (optional), a processor 170, an external interface 180, a power supply 190 and the like. It can be understood by those skilled in the art that FIG. 2 shows merely an example of a terminal or a multifunctional device and does not constitute a limitation of a terminal or a multifunctional device, which may include more or fewer components than shown, or may be a combination of some components, or may be different components.

The input unit 130 may be configured to receive inputted digital or character information, and generate a keyboard signal input related to the user settings and function control of the portable multifunctional apparatus. The input unit 130 may include a touch screen 131 and/or another input device 132. The touch screen 131 may collect touch operations (such as operations on or near the touch screen by users using any suitable object such as a finger, a joint, stylus and the like) by users on or near the touch screen 131, and drive a corresponding connection apparatus according to a preset program. The touch screen may detect a touch operation on the touch screen by a user, convert the touch operation into a touch signal and sends the touch signal to the processor 170, and receive a command sent by the processor 170 and perform the command. The touch signal includes at least coordinate information of a touch point. The touch screen 131 provides an input and output interface between the terminal 100 and the user. In addition, the touch screen may be implemented in multiple types, such as a resistive type, a capacitive type, an infrared type, and a surface acoustic wave type. In addition to the touch screen 131, the input unit 130 may further include another input device 132. The another input device 132 may include but not limited to one or more of a physical keyboard, a function key (such as a volume control key, a switch key), a trackball, a mouse, a joystick, and the like.

The another input device 132 receives the inputted data and the like.

The display unit 140 may be configured to display information inputted by the user or information provided to the user, various menus, interactive interfaces, files of the terminal 100 and/or play any one multimedia file. In the embodiment of the present disclosure, the display unit 140 may be configured to display the interactive interfaces, processing results, and the like in the method for question-answering.

The memory 120 may be configured to store instructions and data. The memory 120 mainly includes an instruction storage area and a data storage area. The data storage area stores various data, such as multimedia files, texts and the like. The instruction storage area stores software units such as an operating system, an application, and instructions required for at least one function, or their subsets or extended sets. The memory 120 may further include a non-volatile random access memory, which provides hardware, software, and data resources in management of computer processing devices to the processor 170, and supports control software and applications. The memory 120 may further be configured to store multimedia files, running programs and applications.

The processor 170 is a control center of the terminal 100, and is connected to various parts of the terminal 100 via various interfaces and lines. The processor 170 performs various functions of the terminal 100 and process data by running or executing instructions stored in the memory 120 and invoking data stored in the memory 120, so as to perform an overall control on the terminal device. In an embodiment, the processor 170 may include one or more processing units. Preferably, the processor 170 may be integrated with an application processor and a modem processor. The application processor mainly processes operating systems, user interfaces, and application programs and the like. The modem processor mainly processes wireless communications. It can be understood that the foregoing modem processor may not be integrated into the processor 170. In some embodiments, the processor and memory may be implemented on a single chip, and in some embodiments, the processor and memory may be implemented individually on separate chips. The processor 170 may further be configured to generate corresponding operational control signals, and send the signals to the corresponding components of the computing and processing device. The processor 170 may further be configured to read and process the data in the software, especially read and process the data and programs in the memory 120, causing respective functional modules to perform the corresponding functions, thereby controlling the corresponding components to operate according to the requirements of the instruction.

The memory 120 may be configured to store software codes related to the method for question-answering. The processor 170 may be configured to perform the steps of the method for question-answering, or schedule other units (such as the input unit 130 and the display unit 140 described above) to implement the corresponding functions.

The radio frequency unit 110 (optional) may be configured to send and receive information, or send and receive a signal during a call. For example, the radio frequency unit 110 receives downlink information from a base station and sends the downlink information to the processor 170 for processing. In addition, the radio frequency unit 110 sends uplink data to the base station. Generally, an RF circuit includes, but is not limited to, an antenna, at least one amplifier, a transceiver, a coupler, a low noise amplifier (LNA), a duplexer, and the like. In addition, the radio frequency unit 110 may further communicate with a network device and another device via wireless communication. The wireless communication may use any communication standard or protocol, including but not limited to Global System of Mobile communication (GSM), General Packet Radio Service (GPRS), Code Division Multiple Access (CDMA), Wideband Code Division Multiple Access (WCDMA), Long Term Evolution (LTE), email, Short Messaging Service (SMS) and the like.

In an embodiment of the present disclosure, the radio frequency unit 110 may send data to the server 200 and receive a processing result sent by the server 200. For example, the Radio frequency 110 sends the received question information of the user to the server 200, and the server 200 obtains an answer corresponding to the question information and returns the answer to the terminal 100 for outputting.

It should be understood that the radio frequency 110 is optional and may be replaced with another communication interface, such as a network interface.

The terminal 100 further includes a power supply 190 (such as a battery) for supplying power to respective components. Preferably, the power supply may be logically connected to the processor 170 via a power management system, thereby implementing functions such as charging, discharging, and power consumption management by using the power management system.

The terminal 100 further includes an external interface 180. The external interface 180 may be a standard Micro USB interface or a multi-pin connector. The external interface 180 may be configured to connect the terminal 100 to other devices for communication, or may be connected to a charger for charging the terminal 100.

Although not shown, the terminal 100 may further include a flash light, a wireless fidelity (WiFi) module, a bluetooth module, sensors with different functions and the like, which will not be described here. Some or all of the method described below may be applied to the terminal 100 as shown in FIG. 2.

The product form of the server 200 in FIG. 1 is described below.

FIG. 3 shows a schematic structural diagram of the server 200. As shown in FIG. 3, the server 200 includes a bus 201, a processing circuit 202, a communication interface 203, and a storage circuit 204. The processing circuit 202, the storage circuit 204, and the communication interface 203 communicate via the bus 201.

The bus 201 may be a peripheral component interconnect (PCI) bus or an extended industry standard architecture (EISA) bus. The bus may include an address bus, a data bus, a control bus and the like. For ease of representation, the bus in FIG. 3 is represented by a thick line, which does not mean that there is only one bus or one type of bus.

The processing circuit 202 may further be referred to as the processor, which may be any one or more processors of a central processing unit (CPU), a graphics processing unit (GPU), a microprocessor (MP), or a digital signal processor (DSP).

The storage circuit 204 may further be referred as the memory, which may include a volatile memory, such as a random access memory (RAM). The storage circuit 204 may further include a non-volatile memory, such as a read-only memory (ROM), a flash memory, a hard drive drive (HDD), or a solid state drive (SSD).

The storage circuit 204 may be configured to store the software codes related to the method for question-answering. The processing circuit 202 may perform the steps of the method for question-answering, and schedule other units to achieve the corresponding functions.

It should be understood that the terminal 100 and server 200 may be centralized or distributed devices. The processor 170 in the terminal 100 and the processing circuit 202 in the server 200 may be hardware circuits (such as an application specific integrated circuit (ASIC), a field-programmable gate array (FPGA), a general processor, a digital signal processor (DSP), a microprocessor, or a microcontroller and the like), or a combination of these hardware circuits. For example, the processor 170 and the processing circuit 202 may be hardware systems with the function of executing instructions, such as a CPU, a DSP and the like, or hardware systems without the function of executing instructions, such as an ASIC, a FPGA, and the like, or a combination of the above hardware systems without the function of executing instructions and the hardware systems with the function of executing instructions.

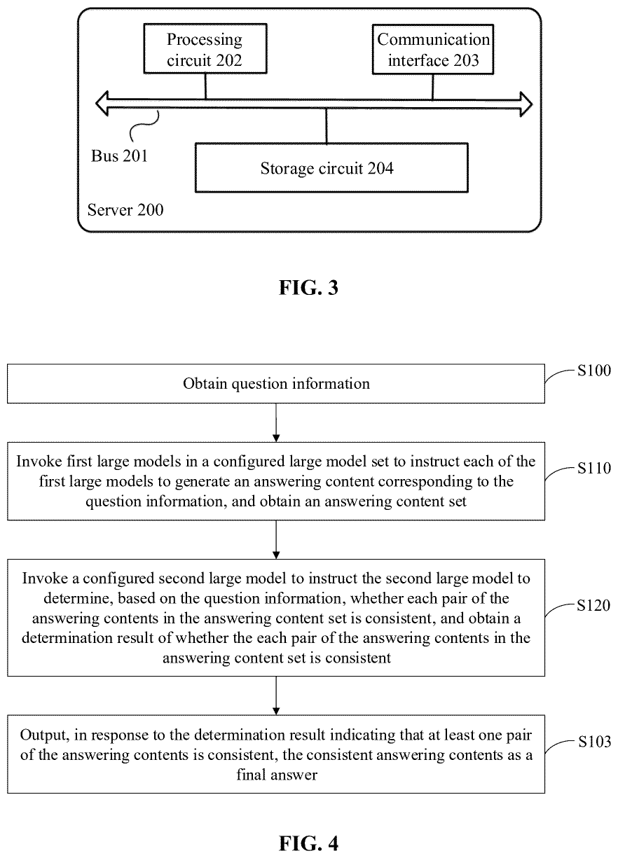

A method for question-answering is provided according to an embodiment of the present disclosure. The method being applied to the computer device in FIG. 1 is taken as an example for illustrating. The computer device may be the terminal 100 in FIG. 1 or a system formed by the terminal 100 and the server 200. Referring to FIG. 4, the method for question-answering includes the following steps S100 to S130.

In step S100, question information is obtained.

In an embodiment, in a human-computer question-answering dialogue scenario, the computer device may obtain the inputted question information. The question information may be inputted in multiple modalities, such as a text form, a voice form, an image form or a video form.

A teaching question-answering scenario is taken as an example, and users take a question as question information.

In step S110, first large models in a configured large model set is invoked to instruct each of the first large models to generate an answering content corresponding to the question information, and an answering content set is obtained.

The large model set includes more than two different first large models. The “first” here is only to distinguish from a “second large model” below. The large model set may include multiple different large models, such as multiple large models developed by different enterprises, or different types and versions of large models developed by one enterprise. The large model set may include large models that have been disclosed currently, or large models that may be developed in the future.

In an embodiment of the present disclosure, multiple large models with respective advantages in different question types may be selected, and be combined as a large model set.

In this step, each first large model in the large model set is invoked to instruct the first large model to generate the answering content corresponding to the question information, so that the set of answering contents generated by the respective first large models in the large model set is obtained.

When the first large model is invoked, a prompt instruction “prompt” is generated based on the question information, and the prompt instruction “prompt” is sent to the first large model to obtain the answering content generated by the first large model.

In step S120, a configured second large model is invoked to instruct the second large model to determine whether each pair of answering contents in the answering content set is consistent based on the question information, and a determination result of whether the each pair of answering contents in the answering content set is consistent is obtained.

In order to determine the consistency of any two answering contents, the answering contents are converted into vector representations, and then the similarity between two vector representations is calculated as a determination standard for determining whether the two answering contents are consistent. For example, the text of the answering contents may be converted into vector representations using technologies such as word embeddings, sentence embeddings and the like, and the similarity between the vector representations is calculated. If the similarity exceeds a set similarity threshold, it is indicated that the two answering contents are consistent. Otherwise, it is indicated that the two answering contents are inconsistent. The answering contents may be converted into the vector representations via embedding models, where the embedding models include, but are not limited to BERT, GPT and the like.

The vector representations map the text to numeric vectors in a high-dimensional space. The vectors capture the semantic information of the text, rather than only the superficial word order and spelling. When the similarity of two embedding vectors is compared, the similarity of the two embedding vectors at the semantic level can be better understood.

However, there are following two difficulties in the above manner.
1. In practice, it is difficult to determine a suitable similarity threshold to determine whether two answering contents express the same meaning. The suitable similarity threshold is generally selected based on experience and experimentation, and the threshold may vary according to different application scenarios.
2. In some scenarios, semantics being similar and answering contents being consistent are two completely different concepts. For example, a choice question is given as the question information, model A gives an answering content that is a specific content of an option A, and model B gives an answering content that is an identifier of the option A. Apparently, the two answering contents are essentially consistent, but the semantics are different. A wrong conclusion may be given when determining whether two answering contents are consistent in the above manner.

Therefore, a solution for determining whether each pair of answering contents is consistent by using a large model is provided according to the present disclosure.

The large model LLM has powerful capabilities of natural language understanding and generation that enable the LLM to perform well in various complex natural language processing tasks. The prompt instruction “prompt” is designed, so as to guide the large model to understand specific question contexts and generate an accurate answer.

The LLM is trained based on large-scale and diverse text data sets and has a capability to process diverse language expressions that enable the LLM to understand and correlate different forms of answers, thereby performing an accurate determination.

The LLM is pre-trained based on large-scale data to acquire a wealth of language and common sense knowledge, which provides the model a relatively solid foundation when performing various questions. For example, when processing a choice question, the LLM understands common question answering patterns and language structures using the knowledge accumulated in the pre-training process, thereby making make a reasonable determination.

The LLM has a reasoning capability to speculate and determine based on a given context. Even if the option and answer are in different forms, the model can deduce their correlations.

On the basis of the capabilities of the above large model, a second large model is pre-configured in the present disclosure. The second large model is another large model different from the first large model. According to the present disclosure, the second large model is invoked to instruct the second large model to refer to the question information (that is, the context information) to determine whether each pair of the answering contents in the answering content set is consistent, and obtain a determination result of whether the each pair of the answering contents in the answering content set is consistent.

In an embodiment, a specific example of a prompt instruct “prompt” is provided as follows:
“Please determine whether the two given answering contents are consistent by referring to the given question information.
Question information: {question information slot}
Answering content 1: {answering content slot}
Answering content 2: {answering content slot}”.

The question information obtained in the above steps may be filled into the question information slot in the “prompt”, and the two to-be-compared answering contents may be respectively filled into the two answering content slots in the “prompt” to obtain an edited “prompt”. The edited “prompt” is sent into the second large model to obtain the determination result of whether the two answering contents are consistent outputted by the second large model.

In an embodiment, the second large model may be implemented by a general large model. In addition, in order to further improve the performance of the second large model in the task of determining the consistency of the answering contents, the general large model is fine-tuned by using the question answering training data, and the large model after fine-tuning training serves as the second large model used in this step. The question answering training data includes sample question information, an answering content pair corresponding to the sample question information, and a determination result of whether the answering content pair is consistent.

The fine-tuning training is performed on the general large model by using the above question answering training data, effectively suppressing a “hallucination” phenomenon of the large model, thereby improving the performance of the large model in the task of determining the consistency of the answering contents.

In step S130, in response to the determination result indicating that at least one pair of the answering contents is consistent, the consistent answering contents are outputted as a final answer.

In an embodiment, if at least one pair of answering contents in the answering content set is consistent, the consistent answering contents are outputted as the final answer.

According to the method for question-answering provided in the embodiments of the present disclosure, multiple large models are integrated for question-answering processing. An answering content corresponding to question information is generated via the first large models in a configured large model set. Further, the second large model is pre-configured according to the present disclosure. The second large model is used to detect the consistency of the answering contents generated by the respective first large models, so as to obtain the determination result of whether each pair of answering contents in the answering content set is consistent. If the determination result indicates that at least one pair of the answering contents is consistent, the consistent answering contents are outputted as the final answer. In view of the fact that an error may exist in an answering content generated by a single large model, mutual validation of the consistency of the answering contents generated by any two large models is performed. If at least one pair of the answering contents is consistent, an accuracy rate of the consistent answering contents is significantly improved. Therefore, the consistent answering contents are outputted as the final answer, thus significantly improving the accuracy rate of the answering result.

Moreover, in the present disclosure, whether the answering contents generated by different first large models are consistent is verified by means of the capability of the second large model. The consistency of each pair of the answering contents is detected via the second large model based on the question information (that is, the context information), during which the reasoning capability of the second large model is fully used, thus improving the accuracy of the consistency detection.

In order to further verify the effectiveness of the solution according to the present disclosure, the following experimental data may be referred to for illustrating.

According to the present disclosure, large models with open api such as gpt and gemini, open source large models and mathematical models fine-tuned based on open source large models are tested on a prepared mathematics comprehensive test set. It is found according to the test that if the accuracy rate of both two large models is only 60%, that is, the two large models have a high probability of giving wrong answers, the reasons for the wrong answers are often different, and the wrong answers are different.

Referring to Table 1 below, on the prepared mathematics comprehensive test set, the accuracy rate of the open source model glm-4-9b-chat is 70.01% and the accuracy rate of gpt3.5 is 66.28%. The answers of the two models are compared via the second large model provided in the present disclosure, where the answers given by the two models on the 1026 questions are consistent, and the accuracy rate of these questions increases to 94.05%, which is 10% higher than gpt4 that has the highest accuracy rate of answering questions with a single model.

In addition, the larger difference in the reasoning process of large models indicates large inconsistency of wrong answers given by the large models when errors occur. For example, for the same large model, the first answer requires the model to answer directly, and the second answer requires the model to generate python codes to be executed by a computer, thereby obtaining the answer. In a case that the answers corresponding to the two completely different paths are the same, the probability of error is relatively low.

TABLE 1

| | The number | The number | | Average | |
|---|---|---|---|---|---|
| | of | of correct | Accuracy | time | |
| Versions | questions | questions | rate | consumption | |
| gpt4 | 1737 | 1450 | 83.48% | 26.79 | s |
| glm-4-9b-chat | 1737 | 1216 | 70.01% | 9.43 | s |
| gpt3.5 | 1737 | 1146 | 65.98% | 7.18 | s |
| glm-4-9b-chat | 1026 | 965 | 94.05% | 10.61 | s |

gpt3.5
(the version that gets to the
same answer via two paths)

With the increase of the number of the first large models used in the large model set, the correct answering content is screened more accurately, achieving a higher accuracy rate.

In addition, in view of the fact that the processing speeds of multiple different first large models in the large model set are different, that is, the time consumptions of generating the answering contents are different. In this embodiment, after all the first large models generate the answering contents, every two answering contents in the answering content set are combined respectively. Then the second large model is invoked in parallel to determine the consistency of each answering content pair, and the determination result of whether the each pair of the answering contents in the answering content set is consistent is obtained.

In addition, in an embodiment, in order to improve the response speed of the computer device for responding rapidly to the input by users, a streaming processing mode may also be adopted. That is, it is continuously detected whether the respective first large models complete generating the answering contents, in response to obtaining two answering contents generated by the first large models, the generated answering contents are combined in a pair, and the second large model is invoked to instruct the second large model to determine whether the two answering contents in each pair of the answering contents are consistent, until the determination result of whether the each pair of the answering contents in the answering content set is consistent is obtained.

That is, in the process of invoking multiple different first large models to generate the answering contents corresponding to the question information, once two first large models generate answering contents, the second large model starts to be invoked to determine the consistency of the two answering contents. Then, as other first large models generate answering contents, the answering contents that have not been combined continue to be combined in pairs, and the second large model is invoked to determine the consistency of the newly combined pairs of answering contents, until the determination result of whether the each pair of the answering contents in the answering content set is consistent is obtained.

During the process, the determination result outputted by the second large model is continuously detected, and the consistent answering content is outputted as the final answer on determining for a first time that the pair of answering contents is consistent.

With the streaming processing mode in the embodiment of the present disclosure, the response speed of devices is increased and the time consumption for waiting for the final answer is reduced.

In some embodiments of the present disclosure, in view of the fact that the accuracy of the output answering content can be maximized using the method described in the above embodiments, the final outputted answer is still inevitably subject to the risk of error, and the risks of the final outputted answers may be different under different circumstances. Therefore, in this embodiment, a step for determining a risk level of the final outputted answer and outputting the risk level is performed.

In an embodiment, after the determination result of whether the each pair of the answering contents in the answering content set is consistent is obtained in step S120, if the determination result indicates that at least one pair of the answering contents is consistent, the risk level of the final answer is determined based on the determination result and the risk level of the final answer is outputted according to the present disclosure.

The risk level is used to characterize the risk of error in the final answer. The strategy for setting the risk level may depends on service requirements. For example, a higher risk level indicates a greater risk of error.

In an embodiment of the present disclosure, the risk level of the final answer may be determined based on the number of answering contents that are consistent with the final answer according to the determination result.

The risk level corresponding to the greater number of answering contents that are consistent with the final answer, indicates a lower risk that an error exists in the final answer.

In an embodiment, if the determination result indicates that all answering contents are consistent, the consistent answering content serves as the final answer, and the corresponding risk level is set to 0 (where a smaller risk level value indicates a lower risk of error). If the determination result indicates that at least one pair of answering contents is consistent, the consistent answering content may serve as the final answer, and the corresponding risk level is set to 1.

In the solution according to the embodiment, the risk level of the final answer is set based on determining the number of answering contents in the answering contents generated by the respective large models that are consistent with the final answer, more accurately measuring the risk of error in the final answer. On the basis of outputting the final answer, the risk level of the final answer is outputted to inform users of the risk of error in the final answer, facilitating users carefully adopting the final answer.

Moreover, according to conventional question answering models, for optimizing the accuracy rate of answering questions, a large amount of data is collected, and a lot of manpower is needed to mark these data. According to the solutions of the present disclosure, a concept of risk level is introduced, the final answer is automatically marked with the risk level on the basis of outputting the final answer corresponding to the question.

Most (about 80%) of questions with low risk level cannot be automatically identified from the data set according to the conventional technology, which requires a lot of manpower. It is worthless to spend manpower costs just for marking the data that the model can perform well. With the solution according to the present disclosure, the questions with low risk level can be automatically identified, greatly saving the manpower costs on identification. In addition, questions with high risk level are marked according to the present disclosure, and a training data set for the questions with high risk level is further constructed, so as to perform targeted optimization training on the first large model, thereby improving the accuracy rate of answering the questions by the first large model.

In some embodiments of the present disclosure, in view of the fact that in the answering content set generated by the respective first large models in large model set, all the answering contents in the answering content set are inconsistent, that is, it is detected by the second large model that the each pair of the answering contents in the answering content set is inconsistent, it is indicated that the first large models in the large model set do not reach a common understanding for the question information. In this case, an alternative solution is provided in the embodiment of the present disclosure as follows.

In the present disclosure, advantage processing question types of the respective first large models in the large model set may be obtained via an experimental test in advance. The advantage processing question type of the first large model is a question type that the first large model is good at processing, that is, the question type that the first large model has a high accuracy rate in answering. Table 2 shows the accuracy rates of two different first large models under different question types as following.

TABLE 2

| Question types | glm-4-9b-chat | gpt3.5 |
|---|---|---|
| All question types | 70.01% | 66.28% |
| Algebraic calculations | 76.14% | 70.90% |
| Composite functions | 81.82% | 100.00% |
| Continuity of function | 80.00% | 55.00% |
| Find limits | 75.00% | 75.00% |
| Arithmetic sequences | 90.48% | 57.14% |
| Binomial theorem | 93.75% | 62.50% |

As shown in Table 2, the difference between the accuracy rates of the two models is large for all question types. However, a model with a low overall accuracy rate is not necessarily meaningless. For example, the model with the lowest overall accuracy rate has the highest accuracy rate for the question type of composite functions.

It can be seen from the above that each of the first large models has a question type that it is good at processing, and the advantage processing question type of each of first large models may be tested and collected. Further, the accuracy rate of each first large model on the advantage processing question type is further recorded.

In view of the above, in a case that all answering contents in the answering content set are inconsistent, a first large model with the advantage processing question type which includes the question information is selected as a target first large model by referring to the advantage processing question types of the respective first large models in the configured large model set. Further, the answering content generated by the target first large model which corresponds to the question information is outputted as the final answer.

Apparently, according to the embodiment, when all answering contents generated by the first large models for the current question information are inconsistent, in order to obtain an answering content corresponding to the question information with a relatively high accuracy rate, the target first large model with an advantage in processing the question type of the current question information may be invoked, and the answering content generated by the target first large model which corresponds to the question information is outputted as the final answer, significantly improving the accuracy rate of the answering content.

Further, in a case that the answering content generated by the above target first large model serves as the final answer, the risk level corresponding to the answering content is further outputted.

In an embodiment, it is noted in the above embodiments that when the advantage processing question types of the respective first large models are obtained, the accuracy rates the first large models on the advantage processing question types are further recorded as shown in Table 2. In view of this, the accuracy rate of the target first large model in processing the question type of the question information may be determined, so that the risk level of the final answer can be determined based on the accuracy rate, and the risk level of the final answer is outputted.

In an embodiment, an accuracy rate threshold may be preset such as 90%. In response to the accuracy rate of the target first large model in processing the question type corresponding to the current question information exceeding the accuracy rate threshold, a first risk level is set. In response to the accuracy rate of the target first large model in processing the current question type corresponding to the question information not exceeding the accuracy rate threshold, a second risk level is set. The risk of error characterized by the first risk level is lower than the risk of error characterized by the second risk level.

In some implementations, if all answering contents in the answering content set are inconsistent, in this case, the risk of error characterized by the determined risk level of the final answer may be higher than a risk of error characterized by a risk level of the final answer when at least one pair of the answering contents is consistent.

For example, the risk levels are defined to include 0, 1, 2, and 3. A larger value indicates a higher risk of error.
1) If the determination result indicates that all the answering contents are consistent, the consistent answering content serves as the final answer, and the corresponding risk level is set to 0.
2) If the determination result indicates that at least one pair of the answering contents is consistent, the consistent answering content may serve as the final answer, and the corresponding risk level is set to 1.
3) If the determination result indicates that all answering contents are inconsistent, the target first large model is invoked to generate the final answer. If the accuracy rate of the target first large model in processing the question type of the question information exceeds the set accuracy rate threshold, the risk level corresponding to the final answer may be set to 2.
4) If the determination result indicates that all answering contents are inconsistent, the target first large model is invoked to generate the final answer. If the accuracy rate of the target first large model in processing the question type of the question information does not exceed the set accuracy rate threshold, the risk level corresponding to the final answer may be set to 3.

In the above embodiment, an example of an optional manner for setting the risk levels is described.

In some embodiments of the present disclosure, in view of the fact that an error may exist in the second large model, and the determination result outputted by the second large model may have a logical error. For example, the second large model determines that an answering content 1 is consistent with an answering content 2, the answering content 2 is consistent with an answering content 3, and the answering content 1 is inconsistent with the answering content 3. Apparently, a logical error exists in the three determination results. Such data is marked automatically, and is manually reviewed to serve as training data for the subsequent update training for the second large model.

In an embodiment, on the basis of the above embodiments, the method for question-answering according to the present disclosure may include:
performing a cross validation on the determination result of the consistency of the each pair of answering contents in the answering content set, and marking, in response to determining that answering contents in the answering content set fail the validation, the answering contents failing the validation as training data for performing update training on the second large model.

The above process of performing a cross validation on the determination result of the consistency may use a pre-configured validation rule. For example, the validation rule may include:
an answering content x being consistent with an answering content z in response to the answering content x being consistent with an answering content y, and the answering content y being consistent with the answering content z.

If the determination result fails the validation rule, relevant answering contents are marked as failing the validation. For example, the answering contents x, y, and z are marked as failing the validation according to the validation rule in the above example.

According to the method in the embodiment, as long as attention is paid to a small part of data that fails the cross validation when performing manual marking, the accuracy rate of the second largest model can be steadily improved, greatly saving the cost of manual marking.

In summary, according to the method for question-answering in the present disclosure, as well as overcoming the defect in the accuracy of a single large model in a short term, the process also benefits from the growth of the respective first large models. For example, large models with excellent performance on the market may be added to the large model set in the present disclosure, thereby steadily improving the accuracy of the final outputted answer.

The apparatus for question-answering in embodiments of the present disclosure is described below. The apparatus for question-answering described below and the method for question-answering described above may be referred to each other.

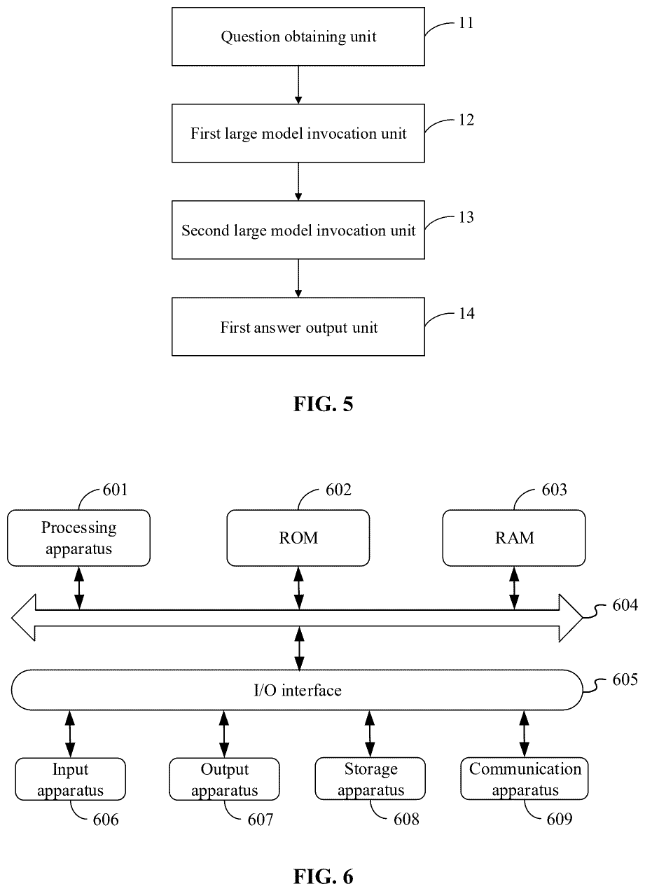

Referring to FIG. 5, FIG. 5 is a schematic structural diagram of an apparatus for question-answering according to an embodiment of the present disclosure.

As shown in FIG. 5, the apparatus may include a question obtaining unit 11, a first large model invocation unit 12, a second large model invocation unit 13, and a first answer output unit 14.

The question obtaining unit 11 is configured to obtain question information.

The first large model invocation unit 12 is configured to invoke first large models in a configured large model set to instruct each of the first large models to generate an answering content corresponding to the question information, and obtain an answering content set. The large model set includes more than two different first large models.

The second large model invocation unit 13 is configured to invoke a configured second large model to instruct the second large model to determine whether each pair of the answering contents in the answering content set is consistent based on the question information, and obtain a determination result of whether the each pair of the answering contents in the answering content set is consistent.

The first answer output unit 14 is configured to output, in response to the determination result indicating that at least one pair of the answering contents is consistent, the consistent answering contents as a final answer.

In an embodiment, the process of the second large model invocation unit invoking a configured second large model, and obtaining a determination result of whether the each pair of answering contents in the answering content set is consistent includes:
continuously detecting whether the first large models have completed generating the answering contents, combining, in response to obtaining two answering contents generated by the first large models, the generated answering contents in a pair, and invoking the second large model to instruct the second large model to determine whether the two answering contents in each pair of the answering contents are consistent, until the determination result of whether the each pair of the answering contents in the answering content set is consistent is obtained;
where the outputting, in response to the determination result indicating that at least one pair of the answering contents is consistent, the consistent answering contents as a final answer includes:
continuously detecting the determination result outputted by the second large model, and outputting the consistent answering content as the final answer on detecting the determination result indicating that one pair of answering contents is consistent for a first time.

In an embodiment, the apparatus according to the present disclosure may further include a first risk level determining unit.

The first risk level determining unit is configured to determine a risk level of the final answer based on the determination result, and output the determined risk level of the final answer. The risk level characterizes a risk of error in the final answer.

In an embodiment, the apparatus according to the present disclosure may further include a second answer output unit.

The second answer output unit is configured to select, in response to the determination result indicating that all the answering contents in the answering content set are inconsistent, a target first large model with an advantage processing question type which includes a question type of the question information by referring to advantage processing question types of the first large models in the configured large model set, and output an answering content generated by the target first large model that corresponds to the question information as the final answer.

In an embodiment, the apparatus according to the present disclosure may further include a second risk level determining unit.

The second risk level determining unit is configured to obtain an accuracy rate of the target first large model for the question type of the question information, where the target first large model is obtained through a pre-test, and determine a risk level of the final answer based on the accuracy rate and output the determined risk level of the final answer. The risk level characterizes a risk of error in the final answer.

In an embodiment, the process of the first risk level determining unit determining the risk level of the final answer based on the determination result includes:
determining the risk level of the final answer based on the number of the answering contents consistent with the final answer in the determination result, where the risk level corresponding to the greater number indicates a lower risk of error in the final answer

In an embodiment, the second large model is obtained by performing fine-tuning training on a general large model using question-answering training data, and the question-answering training data includes sample question information, an answering content pair corresponding to the sample question information, and a determination result of whether the answering content pair is consistent.

In an embodiment, the apparatus according to the present disclosure may further include a cross validation unit.

The cross validation unit is configured to perform a cross validation on the determination result of the consistency of the each pair of the answering contents in the answering content set, and mark, in response to determining that answering contents in the answering content set fail the validation, the answering contents failing the validation as training data for performing update training on the second large model.

An electronic device is further provided in an embodiment of the present disclosure. Referring to FIG. 6, FIG. 6 is a schematic structural diagram of an electronic device according to an embodiment of the present disclosure. The electronic device in the embodiment of the present disclosure may include, but is not limited to, fixed terminals such as a mobile phone, a tablet computer, a learning machine, a teaching large screen, a wearable device and the like. The electronic device shown in FIG. 6 is only an example, and should not be a limitation to a function or usage scope of embodiments of the present disclosure.

As shown in FIG. 6, the electronic device may include a processing apparatus 601 (such as a central processing unit, a graphics processing unit and the like), which can perform various appropriate actions and processes according to programs stored in a ROM (read-only memory) 602 or loaded from a storage apparatus 608 into a RAM (random access memory) 603, so as to implement the method for question-answering in the above embodiments of the present disclosure. When the electronic device is powered on, the RAM 603 also stores various programs and data required for the operation of the electronic device. The processing apparatus 601, ROM 602, and RAM 603 are connected to each other via a public transmission line (also referred to as a bus) 604. An I/O interface (input/output interface) 605 is also connected to the public transmission line 604.

Generally, the I/O interface 605 may be connected to: an input apparatus 606, such as a touch screen, a touch panel, a keyboard, a mouse, a camera, a microphone, an accelerometer, and a gyroscope; an output apparatus 607, such as a liquid crystal display (LCD), a loudspeaker, and a vibrator; a storage apparatus 608, such as a memory card and a hard disk; and a communication apparatus 609. The communication apparatus 609 enables wireless or wired communication between the electronic device and other devices for data exchanging. Although FIG. 6 shows an electronic device provided with various apparatuses, it should be understood that the illustrated apparatuses are not required to all be implemented or included. Alternatively, more or fewer apparatuses may be implemented or included.

In an embodiment of the present disclosure, a computer program product is further provided, including computer-readable instructions. The computer-readable instructions, when being executed on an electronic device, cause the electronic device to perform the method for question-answering according to any one of the embodiments of the present disclosure.

In an embodiment of the present disclosure, a computer-readable storage medium is further provided. The storage medium stores one or more computer programs. The one or more computer programs, when executed on an electronic device, cause the electronic device to perform the method for question-answering according to any one of the embodiments of the present disclosure.

In addition, it should be noted that the apparatus embodiments described above are only schematic. The units described as separate components may be or may not be physically separated. The components displayed as units may be or may not be physical units, that is, may be arranged in the same place or distributed on multiple network units. Some or all of the modules may be selected according to practical requirements to achieve the object of the solution of the embodiments. Moreover, in the drawings of the apparatus embodiments of the present disclosure, connection relationship between modules indicates that the modules are connected communicatively, which may be implemented as one or more communication buses or signal lines.

Through the description of the above embodiments, those skilled in the art can clearly understand that the present disclosure may be implemented by means of a combination of software and necessary general hardware. Alternatively, the present disclosure may also be implemented by special hardware including a special integrated circuit, a special CPU, a special memory, a special component and the like. Generally, all functions implemented by a computer program may be easily implemented by corresponding hardware. In addition, specific hardware used for implementing the same function may has various structures. For example, the hardware may be an analog circuit, a digital circuit, a special circuit or the like. However, for the present disclosure, implementation by a software program is a preferred embodiment in many cases. Based on this understanding, the technical solutions of the present disclosure essentially or a part of the technical solutions that contributes to the conventional technology may be implemented as a software product. The computer software product may be stored in a readable storage medium, such as a floppy disk, a U disk, a mobile hard disk, a ROM, a RAM, a magnetic disk or an optical disk of a computer. The computer software product includes various instructions executed by a computer device (may be a personal computer, a server, a network device and the like) to implement method according to the embodiments of the present disclosure.

All or part of the above embodiments may be implemented by software, hardware, firmware or any combination thereof. When implemented by using software, all or some of the functions may be implemented in a form of a computer program product.

The computer program product includes one or more computer instructions. When the computer program instructions are loaded and executed on a computer, all or part of the processes or functions described in the embodiments of the present disclosure are generated. The computer may be a general computer, a special computer, a computer network, or other programmable apparatus. The computer instructions may be stored in a computer readable storage medium or transmitted from a computer readable storage medium to another computer readable storage medium. For example, the computer instructions may be transmitted from a website site, a computer, a training device or a data center to another website site, another computer, another training device or another data center in a wired manner (for example, through a coaxial cable, optical fiber, and digital subscriber line (DSL)) or in a wireless manner (for example, through infrared, radio, microwave, and the like). The computer readable storage medium may be any available medium capable of being stored by a computer or include a data storage device such as a training device, a data center and the like that are integrated by one or more available mediums. The available medium may be a magnetic medium (such as a floppy disk, a hard disk and a magnetic tape), an optical medium (such as a DVD), a semiconductor medium (such as a solid state disk (SSD)), or the like.

The embodiments in this specification are described in a progressive manner, each of the embodiments emphasizes the differences from other embodiments, and the embodiments may be combined as needed, and the same or similar parts among the embodiments may be referred to each other.

1. A method for question-answering, comprising:
obtaining question information;
invoking first large models in a configured large model set to instruct each of the first large models to generate an answering content corresponding to the question information, and obtaining an answering content set, wherein the large model set comprises more than two different first large models;
invoking a configured second large model to instruct the second large model to determine, based on the question information and the answering contents, whether each pair of the answering contents in the answering content set is consistent, and obtaining a determination result of whether the each pair of the answering contents in the answering content set is consistent; and
outputting, in response to the determination result indicating that at least one pair of the answering contents is consistent, the consistent answering contents as a final answer,
wherein the method further comprises:
performing a cross validation on the determination result of the consistency of the each pair of the answering contents in the answering content set, and marking, in response to determining that answering contents in the answering content set fail the validation, the answering contents failing the validation as training data for performing update training on the second large model, wherein the cross validation is performed on the determination result of the consistency of the each pair of answering contents in the answering content set by using a pre-configured validation rule, and the validation rule comprises: an answering content x being consistent with an answering content z in response to the answering content x being consistent with an answering content y and the answering content y being consistent with the answering content z.

2. The method according to claim 1, further comprising:
selecting, in response to the determination result indicating that all the answering contents in the answering content set are inconsistent, a first large model with an advantage processing question type which comprises a question type of the question information as a target first large model by referring to advantage processing question types of the first large models in the configured large model set; and
outputting an answering content generated by the target first large model that corresponds to the question information as the final answer.

3. The method according to claim 1, wherein the invoking a configured second large model to instruct the second large model to determine, based on the question information and the answering contents, whether each pair of the answering contents in the answering content set is consistent, and obtaining a determination result of whether the each pair of the answering contents in the answering content set is consistent comprises:
continuously detecting whether the first large models have completed generating the answering contents, combining, in response to obtaining two answering contents generated by the first large models, the generated answering contents in a pair, and invoking the second large model to instruct the second large model to determine whether the two answering contents in each pair of the answering contents are consistent, until the determination result of whether the each pair of the answering contents in the answering content set is consistent is obtained; and
wherein the outputting, in response to the determination result indicating that at least one pair of the answering contents is consistent, the consistent answering contents as a final answer comprises:
continuously detecting the determination result outputted by the second large model, and outputting the consistent answering content as the final answer on detecting the determination result indicating that one pair of answering contents is consistent for a first time.

4. The method according to claim 1, further comprising:
determining a risk level of the final answer based on the determination result, and outputting the determined risk level of the final answer, wherein the risk level characterizes a risk of error in the final answer.

5. The method according to claim 2, further comprising:
obtaining an accuracy rate of the target first large model for the question type of the question information, wherein the target first large model is obtained through a pre-test; and
determining a risk level of the final answer based on the accuracy rate and outputting the determined risk level of the final answer, wherein the risk level characterizes a risk of error in the final answer.

6. The method according to claim 4, wherein the determining a risk level of the final answer based on the determination result comprises:
determining the risk level of the final answer based on the number of the answering contents consistent with the final answer in the determination result, wherein the risk level corresponding to the greater number indicates a lower risk of error in the final answer.

7. The method according to claim 1, wherein the second large model is obtained by performing fine-tuning training on a general large model using question-answering training data, and the question-answering training data comprises sample question information, an answering content pair corresponding to the sample question information, and a determination result of whether the answering content pair is consistent.

8. An apparatus for question-answering, comprising:
a question obtaining unit, configured to obtain question information;
a first large model invocation unit, configured to invoke first large models in a configured large model set to instruct each of the first large models to generate an answering content corresponding to the question information, and obtain an answering content set, wherein the large model set comprises more than two different first large models;
a second large model invocation unit, configured to invoke a configured second large model to instruct the second large model to determine whether each pair of the answering contents in the answering content set is consistent based on the question information and the answering contents, and obtain a determination result of whether the each pair of the answering contents in the answering content set is consistent; and
a first answer output unit, configured to output, in response to the determination result indicating that at least one pair of the answering contents is consistent, the consistent answering contents as a final answer,
wherein the apparatus further comprises:
a cross validation unit, configured to perform a cross validation on the determination result of the consistency of the each pair of the answering contents in the answering content set, and mark, in response to determining that answering contents in the answering content set fail the validation, the answering contents failing the validation as training data for performing update training on the second large model, wherein the cross validation is performed on the determination result of the consistency of the each pair of answering contents in the answering content set by using a pre-configured validation rule, and the validation rule comprises: an answering content x being consistent with an answering content z in response to the answering content x being consistent with an answering content y and the answering content y being consistent with the answering content z.

9. An electronic device, comprising: a memory and a processor; wherein
the memory is configured to store a program; and
the processor is configured to execute the program to perform the method for question-answering according to claim 1.

10. A readable storage medium, storing a computer program, wherein the computer program, when being executed by a processor, performs the method for question-answering according to claim 1.

11. A computer program product, comprising a computer program, wherein the computer program, when being executed by a processor, performs the method for question-answering according to claim 1.
